(19) United States
(12) Patent Application Publication
(10) Pub. No.: US 2019/0262758 A1
(43) Pub. Date: Aug. 29, 2019

(54) Filter And Method For Producing A Filter

(71) Applicant: CPT GROUP GmbH, Hannover (DE)

(72) Inventors: Peter HIRTH, Rösrath (DE); Rolf BRÜCK, Bergisch Gladbach (DE); Thomas HÄRIG, Neunkirchen-Seelschied (DE); Ferdi KURTH, Mechernich (DE); Sven SCHEPERS, Troisdorf (DE)

(73) Assignee: CPT GROUP GmbH, Hannover (DE)

(21) Appl. No.: 16/343,466

(22) PCT Filed: Oct. 16, 2017
(86) PCT No.: PCT/EP2017/076276

§ 371 Date: Apr. 19, 2019

(30) Foreign Application Priority Data
Oct. 21, 2016 (DE) 10 2016 220 707.5

(51) Int. Cl. B01D 46/52; F01N 3/022; B01D 46/00; B01D 46/10; B01D 39/10; B01D 39/20

(52) U.S. Cl. CPC B01D 46/523; F01N 3/022; B01D 46/0021; B01D 2279/30; B01D 46/0001; B01D 39/10; B01D 39/2041; B01D 46/106

(57) ABSTRACT

A filter for the purification of exhaust gases of an internal combustion engine includes: a housing that can be flowed through by exhaust gas in an axial direction and has an inflow side and an outflow side; a filter body is formed in the housing from a plurality of filter layers, which filter body can be flowed through by the exhaust gas flowing through the housing. The filter layers are of annular form and are arranged concentrically with respect to one another, wherein, in alternating fashion, two filter layers adjacent to one another in a radial direction are connected to one another in fluid-tight fashion at the inflow side, and two filter layers adjacent to one another in a radial direction are connected to one another at the outflow side.

### CROSS REFERENCE TO RELATED APPLICATIONS

This is a U.S. national stage of International application No. PCT/EP2017/076276, filed on Oct. 16, 2017, which claims priority to German Application No. DE102016220 707.5, filed Oct. 21, 2016, the content of each of which is incorporated herein by reference.

### BACKGROUND OF THE INVENTION

### 1. Field of the Invention

The invention relates to a filter for the purification of exhaust gases of an internal combustion engine, and to a method for producing such a filter.

### 2. Description of the Prior Art

The exhaust gases of internal combustion engines comprise not only the gaseous constituents but also solids that flow as particles with the exhaust gas. These particles, if they are not subjected to suitable aftertreatment, emerge with the exhaust gas into the environment and can lead there to contamination and a chemical burden. In particular, sufficiently small particles, which are in part respirable, can lead to a burden on human health.

To prevent the emergence of such particles into the environment, it is necessary to provide suitable filters in the exhaust tract. Filters of this type are known in a wide variety of variants in the prior art. They are designed and configured substantially for use in exhaust tracts of diesel engines. Since, in the future, an increasing focus will be placed on exhaust-gas aftertreatment in gasoline engines, it is necessary to provide filters for the exhaust tract of gasoline engines, in particular of direct-injection gasoline engines, which filters are adapted to the higher temperature levels and the different pressures of the exhaust gas. Furthermore, the filters must be adapted to the particle sizes that arise specifically in the case of the combustion of gasoline.

### SUMMARY OF THE INVENTION

A problem addressed by an aspect of the present invention is therefore creating a filter that permits the filtering of particles in the exhaust gas of an internal combustion engine operated with gasoline. Here, the filter preferably should have, in particular, a compact and robust structural form and be capable of being adapted, using simple structure, for use in exhaust tracts with different line cross sections. Here, the filter preferably should have a high volume-specific surface area and should generate the lowest possible counterpressure whilst realizing a simultaneously high separation efficiency. A further problem addressed is providing a method for producing such a filter.

According to one aspect of the invention, problems relating to filters may be solved by a filter for the purification of exhaust gases of an internal combustion engine, having a housing that can be flowed through by exhaust gas in an axial direction and that has an inflow side and an outflow side, wherein a filter body is formed in the housing from a multiplicity of filter layers, which filter body can be flowed through by the exhaust gas that can be caused to flow through the housing, wherein the filter layers are of annular form and are arranged concentrically with respect to one another, wherein, in alternating fashion, two filter layers adjacent to one another in a radial direction are connected to one another in fluid-tight fashion at the inflow side, and two filter layers adjacent to one another in a radial direction are connected to one another at the outflow side.

In one aspect, the filter body is, overall, constructed such that exhaust gas can flow from the inflow side into the flow channels formed between the mutually concentrically arranged filter layers. Here, the exhaust gas flows along an axial direction into the flow channels. However, owing to the type of construction, the flow channels are closed off toward the outlet side, whereby the exhaust gas is diverted in a radial direction. The filter layers are formed such that the exhaust gas can flow through them but particles of a certain defined minimum size are retained by the filter layers. The exhaust gas can thus, as a result of the radial deflection, flow across into the respectively adjacent flow channels, which extend from the inflow side toward the outflow side. After passing over into the radially adjacently arranged flow channel, the exhaust gas can flow in an axial direction toward the outflow side and finally flow out of the filter body.

Owing to the fluid-tight connection of the respective filter layers at the inflow side and at the outflow side, a direct throughflow in the axial direction is prevented.

It is particularly advantageous if the filter body has, in alternating fashion in a radial direction, flow channels that narrow from the inflow side toward the outflow side and flow channels that narrow from the outflow side toward the inflow side. This is advantageous in order to permit as easy as possible an inflow and outflow into the filter body and out of the filter body. Owing to the relatively large opening cross section of the flow channels at the inflow side and at the outflow side, the inflow is facilitated. As a result of the narrowing of the flow channels from the inflow side toward the outflow side, the cross-sectional area through which flow can pass is reduced, whereby the passage of the exhaust gas through the filter layer into the respectively adjacent flow channels is promoted. The flow channels, which then widen toward the outflow side, lead to an easier outflow of the exhaust gas after it passes through the filter layers.

It is also advantageous if the filter body has an undulating form in a section along the central axis of the housing, wherein the undulation runs between the inflow side and the outflow side. By this undulating form, it is ensured that the cross-sectional area of the flow channels is as large as possible at the inflow side and the outflow side, whereby the inflow and the outflow are made easier. By the cross section of the flow channels which initially becomes smaller in the flow direction, the passage of the exhaust gas through the filter layer that spatially delimits the flow channel is forced.

Major influential factors for the flow through the filter body are the exhaust-gas flow rate in the flow channel, the flow velocity and the pressure loss caused as a result of the flow through the filter layer. By the flow channels that initially narrow and the flow channels that widen after the passage through the filter layer, a particularly advantageous structural form is realized that promotes the flow through the filter layers, whereby, overall, a low pressure loss is caused by the filter body and the purification rate is particularly high.

In a preferred aspect of the present invention, the filter layers are formed by a metal nonwoven. A metal nonwoven is, for example, produced by the sintering of areally distributed metal filaments. A metal nonwoven has the advantage that it is particularly temperature-resistant, which is expedient in particular for the use in internal combustion engines operated with gasoline. Furthermore, such a metal nonwoven can be easily adjusted to the respectively required pore size. Furthermore, it is particularly easy to mechanically deform, whereby, in particular, the production process is simplified.

It is also preferred if the filter layers have, at the end regions facing toward the inflow side and/or at the end regions facing toward the outflow side, a fluid-impermeable metal strip that runs in a circumferential direction.

Such a metal strip is advantageous in particular in order to be able to solder or weld the filter layers to one another or connect these to one another in some other way. It is furthermore conducive to increasing the stability of the individual filter layers.

It is furthermore advantageous if the individual filter layers are formed by metal foils that are rolled up in annular fashion, wherein the cross-section of the respective filter layers conically narrows or conically widens from the inflow side in the direction of the outflow side. By these filter layers that are rolled up in annular fashion and that narrow in each case from the inflow side to the outflow side or from the outflow side to the inflow side, the flow channels with their cross sections which narrow along the flow direction, and which widen after the passage through the filter layer, can be generated in a particularly advantageous manner.

It is furthermore advantageous if in each case two filter layers directly adjacent to one another in a radial direction are connected to one another in fluid-tight fashion at the inflow side or the outflow side. This is particularly advantageous to prevent exhaust gas from being able to flow through unfiltered at the joint between two filter layers.

It is also expedient if the filter layers that are in each case connected to one another in fluid-tight fashion are inserted at an end side into groove-like rings, and the respective end regions of the filter layers are encompassed by the groove-like rings. In particular, the joint between the two filter layers is covered by the groove-like ring. The groove-like ring may, for example, also have a V-shaped cross section, such that the metal strips of the filter layers, which are inclined at a defined angle with respect to one another, are seated in an accurately fitting manner in the ring.

It is also advantageous for the groove-like ring to be filled with a solder material, which can be utilized for the soldering of the two respectively inserted filter layers.

It is furthermore advantageous if, between two filter layers connected to one another in fluid-tight fashion, there is arranged a seal that runs in a circumferential direction. A seal is advantageous for preventing the undesired throughflow at the joint. The seal may, for example, be formed by an additional metal strip. Also, the seal may advantageously be formed by a metal strip composed partially of a solder material that liquefies in the presence of the temperatures required for a soldering process and that connects the two filter layers to one another in fluid-tight fashion when it cools.

It is furthermore expedient if that first filter layer, which is outermost in a radial direction, is connected at the inflow side in fluid-tight fashion in a circumferential direction to the housing, and the first filter layer is connected at the outflow side in fluid-tight fashion in a circumferential direction to that second filter layer directly adjacent in a radial direction toward the center, and the second filter layer is connected at the inflow side in fluid-tight fashion in a circumferential direction to that filter layer, which is third in the radial direction, wherein this connection principle continues as far as the innermost filter layer as viewed in a radial direction, which innermost filter layer is closed off with itself in fluid-tight fashion at the end side at the inflow side or the outflow side.

This principle of the connection of the filter layers to one another leads to a filter body having flow channels that each narrow from the inflow side toward the outflow side, whereas those flow channels through which flow can pass only after the passage through a filter layer widen from the inflow side toward the outflow side. Altogether, this yields a filter body through which flow can pass in a particularly effective manner, which filter body firstly has a high purification action, because all of the exhaust gas must imperatively flow through the filter, and secondly generates a low pressure loss.

It is also preferable if, between two filter layers that are directly adjacent to one another in a radial direction, there is arranged an undulating spacer that runs in a circumferential direction. Such a spacer may be formed for example by an undulating ring that extends a few millimeters into the filter body proceeding from the inflow side or the outflow side. The spacer preferably extends no further into the filter body than the fluid-impermeable metal strip formed on the filter layers. It is thus ensured that no filter area is covered by the spacer.

It is furthermore advantageous if that filter layer innermost in a radial direction is closed off in fluid-tight fashion at the end side toward the inflow side or toward the outflow side, whereby the filter layer has a conical basic form. This is necessary in order to prevent exhaust gas from flowing across in the center of the filter body without being filtered.

It is furthermore advantageous if the annular filter layers have an undulation running in a circumferential direction of the filter body. An undulation is advantageous for increasing the stability of the individual filter layers, whereby the filter body as a whole is made more stable. Additionally, by the undulation, in particular that surface of the filter layer that spatially delimits a respective flow channel is enlarged in relation to a non-undulating ring.

The undulation is preferably configured so as to form the undulation peaks and the undulation troughs in a radial direction out of the otherwise annular filter layer. By an undulation of the filter layers, it is possible in particular to realize an enlargement of the filter area. It is preferable for the filter area of the otherwise annular filter layers to be enlarged by a factor of 1.2 to 4 by the undulation. Here, it is particularly preferable for the filter area to be enlarged by a factor of 1.5 to 3.

It is also expedient if those filter layers that are adjacent to one another in a radial direction, with the exception of that filter layer that is outermost in a radial direction and the innermost filter layer, have the same number of undulation peaks and undulation troughs in a circumferential direction. This is advantageous to be able to more effectively connect the in each case mutually adjacent filter layers to one another. In particular, in order to permit an as far as possible stress-free and dimensionally stable connection, there should be the least possible differences in terms of shaping and dimensions between those regions of two filter layers to be connected to one another in each case. Owing to the use in an exhaust tract of an internal combustion engine, increased mechanical and thermal loads are to be expected, which may each cause damage to a connecting point, in particular if the connecting point is under mechanical stress.

In order to further reduce stresses in the connection of two filter layers, or even eliminate such stresses entirely, it is advantageous for the circumferences of mutually directly adjacently arranged filter layers to also be of equal size at least in the region of the connecting points.

It is furthermore advantageous if the amplitude of the undulation peaks and of the undulation troughs on the filter layers increases from the outside inward in a radial direction of the filter body. This arises from the fact that the filter layers preferably all have the same number of undulation peaks and undulation troughs. Owing to the diameter which naturally becomes smaller in an inward radial direction, the amplitudes of the undulation peaks and undulation troughs must increase.

According to another aspect of the invention, a method is provided for producing a filter, wherein the filter body is formed from a multiplicity of filter layers arranged concentrically with respect to one another and inserted into a housing, wherein the individual filter layers are formed by virtue of a metal foil being wound in annular fashion, and the annular metal foils are subsequently pulled over a conically widening molding element, wherein the filter layers which form the filter body are, from the inside outward, pulled in each case a defined distance further over the conically widening molding element in order to realize conical filter layers with an increasing diameter.

A filter body is preferably generated only from filter layers of one size. The filter layer in the filter body with the smallest cross section thus substantially determines the size of the filter layers in the initial state. As a result of the annular filter layers being pulled over a conically widening molding element, the annular filter layers can be expanded. Depending on how far an annular filter element is pulled over the molding element, it is expanded and likewise assumes a conical shape. If an undulating annular filter layer is pulled over the conical molding body or cone, the undulation height of the individual filter layer is reduced to a greater or lesser extent during the expansion in a manner dependent on how far the undulating ring is pulled over the cone. If the annular filter layer is pulled as far as the end of the cone, the undulation height is reduced to a maximum extent.

In this way, filter layers can be generated up to a certain maximum diameter. The maximum diameter that can be generated is in this case in particular dependent on the material characteristics of the filter layer. By this method, it is particularly easy to obtain the individual filter layers with different diameters and a conical shaping from uniform starting products.

It is also advantageous if the annular filter layers have an undulating form in a circumferential direction, wherein, as a result of the expansion of the annular filter layers on the molding element, the amplitude of the undulation decreases to an ever greater extent the further the filter layer is pulled over the molding element. As a result of the annular filter layers being pulled over the conical molding element, the filter layer is expanded. Owing to the conical shape of the molding element, this occurs more at one of the axial end regions than at the respective other axial end region.

It is furthermore advantageous if the conically tapering filter layers are inserted one inside the other such that those filter layers directly adjacent to one another in a radial direction are arranged alternately with the relatively small cross-sectional area toward the inflow side and toward the outflow side, giving rise to an accordion-like construction of the filter body, wherein the average cross-section of the filter layers decreases in a radial direction from the outside inward. By such an arrangement of the individual filter layers relative to one another, a filter body with the structure according to the invention can be produced particularly easily.

Advantageous refinements of the present invention are described in the following description of the figures.

### BRIEF DESCRIPTION OF THE DRAWINGS

The invention will be explained in detail in the following on the basis of exemplary embodiments with reference to the drawings, in which:

FIG. 1 shows a schematic view of the inflow side of the filter body;

FIGS. 2A and 2B show sectional views through the joint of two filter layers;

FIG. 3 shows a perspective view of an annular filter layer formed from an undulating metal nonwoven with metal strips at the end sides;

FIG. 4 shows a view of an annular filter layer as in FIG. 3, wherein the filter layer has been pulled over a conically widening molding element;

FIG. 5A shows a diagrammatic sketch showing two filter layers that have been inserted into a groove-like ring;

FIG. 5B shows a groove-like ring which has an undulation in a circumferential direction, which undulation is adapted to the undulation of the annular filter layers;

FIG. 6 shows a view of a so-called filter bag which has been formed from a filter layer and which forms that filter layer of the filter body which is innermost in a radial direction, and

FIG. 7 shows a section along the central axis through the housing of the filter, wherein the individual mutually concentrically arranged filter layers are likewise illustrated in section.

### DETAILED DESCRIPTION OF THE PRESENTLY PREFERRED EMBODIMENTS

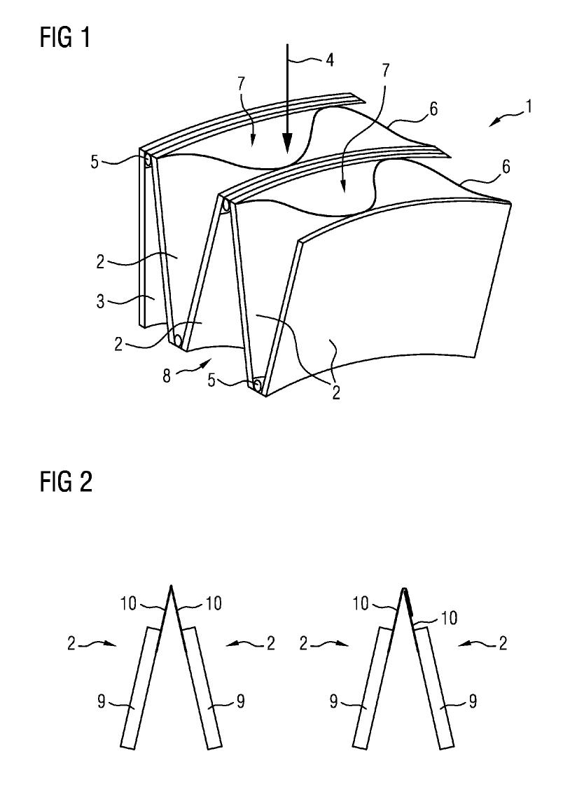

FIG. 1 shows a partial detail of a filter body 1. The filter body 1 is formed from a multiplicity of filter layers 2, which are arranged concentrically with respect to one another. The filter layers 2 have a conical profile.

The arrow 4 illustrates the direction of the exhaust gas flowing through the filter body 1. That filter layer 2 which is outermost in a radial direction is connected directly to the housing wall 3 in a circumferential direction. Between the filter layers 2, in particular at the joints between two mutually adjacent filter layers 2, there is arranged a sealing element (seal) 5 which runs in encircling fashion in a circumferential direction. Such a seal is also arranged at the joint between the outermost filter layer 2 and the housing 3.

At the inflow side, respective undulating spacers 6 are additionally arranged between the filter layers. The spacers 6 space the mutually adjacent filter layers 2 apart from one another and increase the stability of the filter body 1.

The conical design of the filter layers 2 and the respectively alternating arrangement of the filter layers 2 such that the end region of the filter layer 2 with the relatively small diameter is arranged alternately toward the inflow side and toward the outflow side give rise to the undulating construction of the filter body 1. In particular, the flow channels 7, which narrow from the inflow side toward the outflow side, and the flow channels 8, which widen from the inflow side toward the outflow side, are formed in this way.

FIG. 2A shows a section through a joint between two filter layers 2, wherein the filter layers shown have a region 9 composed of a metal nonwoven and a region 10 formed from a fluid-impermeable metal strip. FIG. 2A shows in particular the joint between two mutually directly adjacently arranged filter layers 2.

In FIG. 2A, the two filter layers 2 abut directly against one another at an acute angle. They can be soldered to one another by means of the application of a solder. Alternatively, use may for example also be made of roll welding methods in order to generate a permanently fluid-tight connection between the two filter layers 2.

In FIG. 2B, the left-hand filter layer 2 has been folded over the right-hand filter layer 2 at the joint. Here, in particular, the region 10 formed by the metal strip has been bent over the end region of the right-hand filter layer 2. By means of this construction, it is possible for a fluid-tight connection of the filter layers to be realized in a simple manner, because a double-layer configuration is generated in the region of the joint.

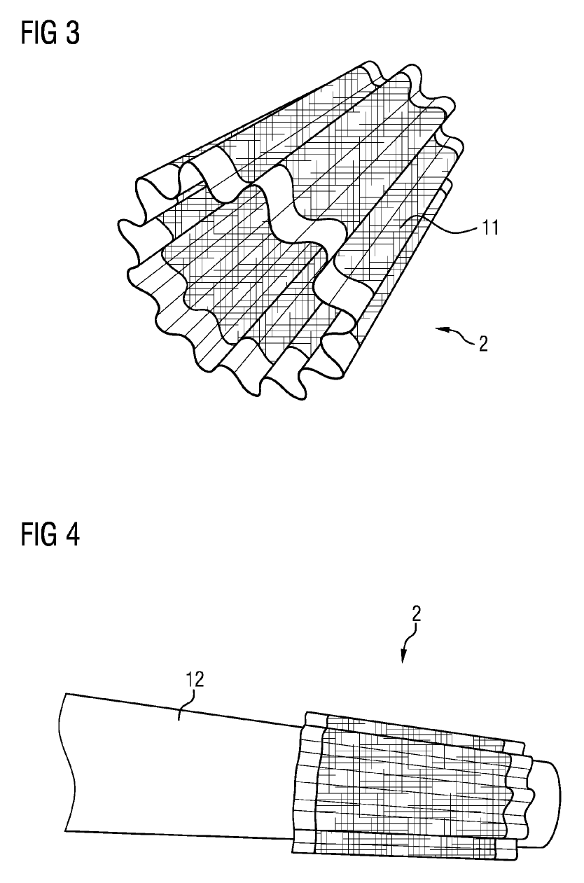

FIG. 3 shows a perspective view of an annular filter layer 2, which is formed from a corrugated metal nonwoven 11. The filter layer 2 has, at the axial end regions, in each case one metal strip 10 running in a circumferential direction, as has already been shown in FIGS. 2A and 2B. Between the metal strips 10, there is arranged a metal nonwoven, 9 which forms the filter material itself.

The annular filter layer 2 is of conical shape, such that the cross section of one axial end region is smaller than the cross section of the other axial end region.

FIG. 4 shows the annular filter layer 2 of FIG. 3 while the filter layer is mounted on a molding element 12. The molding element 12 has a cross section that widens conically from the tip. As a result of the filter layer 2 being pushed onto the molding element 12, it is thus possible for the filter layer 2 to assume a conical shaping. The further the filter layer 2 is pushed over the molding element 12 proceeding from the tip, the more intensely the filter layer is expanded. As a result of being pushed onto the molding element 12 to different extents, it is thus possible for filter layers 2 with different diameters at their respective axial end regions to be molded from identical blanks.

FIG. 5A shows two filter layers 2 which are again formed from a metal nonwoven 9 and a metal strip 10, which are inserted into a groove-like ring 13. The metal strips 10 in particular are inserted into the groove-like ring 13. To realize a fluid-tight connection between the filter layers 2, it is possible for the filter layers 2 to be for example soldered or welded to the groove-like ring 13.

FIG. 5B shows a perspective view of a groove-like ring 13, which is adapted to the shaping of the undulating filter layers 2 from FIGS. 3 and 4.

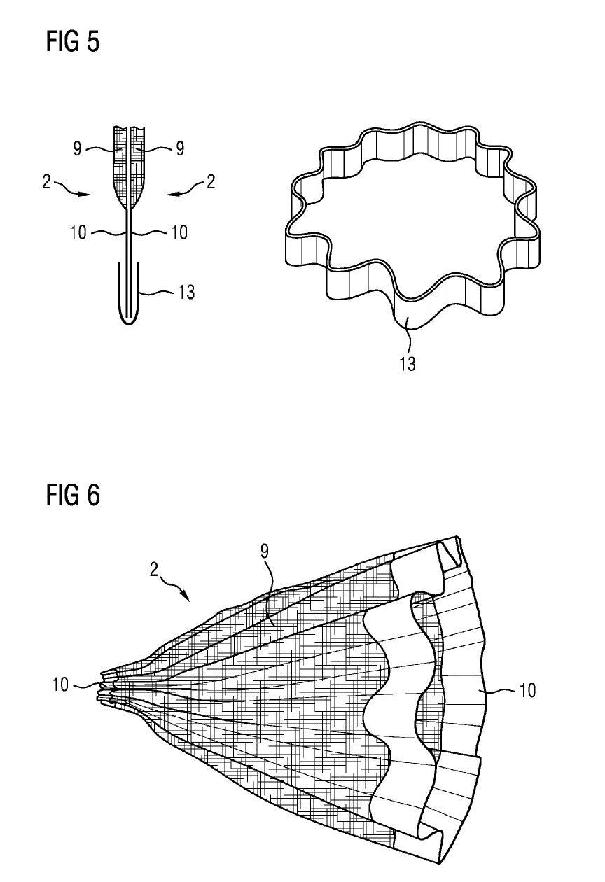

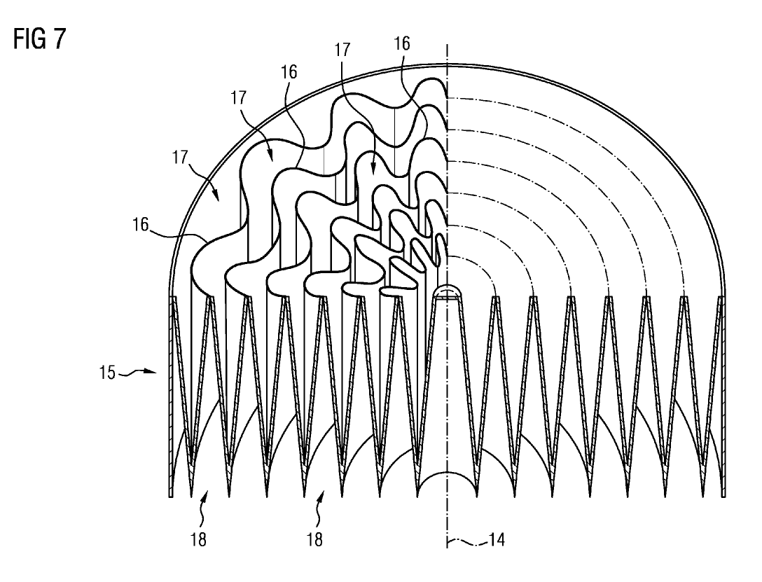

FIG. 6 shows an undulating filter layer 2 that has been deformed to form a bag-like structure. Here, in particular, one axial end region of the filter layer 2 in question has been folded together such that the metal strip 10 lies against itself at multiple points. The filter layer 2 can be closed off in fluid-tight fashion by virtue of the contact points between the individual regions of the metal strip 10 being soldered.

This so-called filter bag forms specifically the filter layer situated in the center, as viewed in a radial direction of the filter body.

FIG. 7 shows a section along the central axis 14 through the housing 15 of the filter. Illustrated in the housing 15 are multiple mutually concentrically arranged filter layers 16 formed as undulating annular elements.

The housing 15 is formed by a ring that delimits the filter body in a radial direction. That filter layer 16 outermost in a radial direction is connected in fluid-tight fashion to the housing 15 in the upper end region of the housing 15, such that no exhaust gas can flow through the filter past the filter layer without being filtered.

The filter layers 16 all have an undulation running in encircling fashion in a circumferential direction, wherein all of the filter layers 16 aside from the layer innermost in a radial direction have the same number of undulation troughs and undulation peaks. The amplitude of the individual undulations increases in a radial direction from the outside inward. This is achieved by virtue of preferably all of the annular filter layers 16 being produced from the same blank. By virtue of the annular blanks being expanded by a conical molding element, the filter layers 16 firstly obtain their conical shape and secondly obtain their final diameter. The more intensely the filter layers 16 are expanded, the more intensely the undulations are flattened.

That filter layer 16 outermost in a radial direction practically no longer has an undulation at least at the joint with the housing 15, and can thus be connected to the housing in fluid-tight fashion in a particularly effective manner.

In the section of FIG. 7, it can be clearly seen that the flow channels 17 at the inflow side, which is, for example, at the top in FIG. 7, narrow with increasing inflow depth. The exhaust gas can, practically along the entirety of the filter layers 16, flow across into the flow channels 18 adjacent to the respective filter layer 16. The flow channels 18 increase from the inflow side toward the outflow side situated at the bottom.

The section through the filter shows the basically accordion-like construction of the filter body in the housing 15. The filter layer that is innermost in a radial direction has been deformed to form a bag-like element and has been closed off in fluid-tight fashion at one side, such that flow cannot pass through this end region.

The different features of the individual exemplary embodiments can also be combined with one another. The exemplary embodiments in FIGS. 1 to 6 are in particular not of a limiting nature and serve for illustrating the concept of the invention.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-18. (canceled)

19. A filter for the purification of exhaust gases of an internal combustion engine, comprising:
a housing configured to be flowed through by the exhaust gases in an axial direction and having an inflow side and an outflow side; and
a filter body arranged in the housing, the filter body comprising a plurality of annular filter layers, the filter body configured to be flowed through by the exhaust gases flowing through the housing,
wherein the annular filter layers (2, 16) are arranged concentrically with respect to one another, wherein, in alternating fashion, two annular filter layers (2, 16) radially adjacent to one another are connected to one another in fluid-tight fashion at the inflow side, and two annular filter layers (2, 16) radially adjacent to one another are connected to one another at the outflow side.

20. The filter as claimed in claim 19, wherein the filter body (1) has, in alternating fashion in a radial direction, first flow channels (7, 17) that narrow from the inflow side toward the outflow side and second flow channels (8, 18) that narrow from the outflow side toward the inflow side.

21. The filter as claimed in claim 19, wherein the filter body (1) has an undulating configuration in a section along the central axis (14) of the housing (3, 15), wherein the undulation runs between the inflow side and the outflow side.

22. The filter as claimed in claim 19, wherein the annular filter layers (2, 16) are formed by a metal nonwoven (9).

23. The filter as claimed in claim 19, wherein the annular filter layers (2, 16) have, at end regions facing toward the inflow side and/or at end regions facing toward the outflow side, a fluid-impermeable metal strip (10) that runs in a circumferential direction.

24. The filter as claimed in claim 19, wherein the individual filter layers (2, 16) are formed by metal foils rolled up in annular fashion, wherein the cross-section of the respective filter layers (2, 16) conically narrows or conically widens from the inflow side in the direction of the outflow side.

25. The filter as claimed in claim 19, wherein any two filter layers (2, 16) directly adjacent to one another in a radial direction are connected to one another in fluid-tight fashion at the inflow side or the outflow side.

26. The filter as claimed in claim 25, wherein the filter layers (2, 16) connected to one another in fluid-tight fashion are inserted at an end side into groove-like rings (13), and respective end regions of the filter layers (2, 16) are encompassed by the groove-like rings (13).

27. The filter as claimed in claim 19, wherein, between a seal element (5) is arranged between two filter layers (2, 16) connected to one another in fluid-tight fashion, the seal element (5) being arranged and configured to run in a circumferential direction.

28. The filter as claimed in claim 19, wherein a first filter layer (2, 16) that is outermost in a radial direction is connected at the inflow side in fluid-tight fashion in a circumferential direction to the housing (3, 15), and the first filter layer (2, 16) is connected at the outflow side in fluid-tight fashion in a circumferential direction to a second filter layer (2, 16) directly adjacent in a radial direction toward the center, and the second filter layer (2, 16) is connected at the inflow side in fluid-tight fashion in a circumferential direction to a third filter layer (2, 16) arranged third in the radial direction, wherein this connection arrangement continues as far as an innermost filter layer (2, 16) as viewed in a radial direction, the innermost filter layer being closed off with itself in fluid-tight fashion at the end side at the inflow side or the outflow side.

29. The filter as claimed in claim 19, wherein an undulating spacer element (6) is arranged between two filter layers (2, 16) that are directly adjacent to one another in a radial direction, the undulating spacer element (6) being arranged and configured to run in a circumferential direction.

30. The filter as claimed in claim 19, wherein a radially innermost filter layer (2, 16) is closed off in fluid-tight fashion at the end side toward the inflow side or toward the outflow side, such that the filter layer has a conical basic shape.

31. The filter as claimed in claim 19, wherein the annular filter layers (2, 16) have an undulation running in a circumferential direction of the filter body (1).

32. The filter as claimed in claim 31, wherein radially adjacent ones of the filter layers (2, 16), other than a radially outermost filter layer (2, 16) and a radially innermost filter layer, have the same number of undulation peaks and undulation troughs in a circumferential direction.

33. The filter as claimed in claim 32, wherein the amplitude of the undulation peaks and of the undulation troughs on the filter layers (2, 16) increases, from the outside, inward in a radial direction of the filter body (1).

34. A method for producing a filter as claimed in claim 19, wherein the filter body (1) is formed from the plurality of annular filter layers (2, 16), the method comprising:
arranging the plurality of filter layers (2, 16) concentrically with respect to one another;
inserting the concentrically arranged filter layers (2, 16), into the housing;
winding, in annular fashion, a metal foil, to form the individual filter layers (2, 16); and
subsequently pulling the annular metal foils over a conically widening molding element (12), wherein the filter layers (2, 16) which form the filter body (1) are, from the inside outward, pulled in each case a defined distance further over the conically widening molding element (12) to realize conically tapering filter layers (2, 16) with an increasing diameter.

35. The method as claimed in claim 34, wherein the annular filter layers (2, 16) have an undulating form in a circumferential direction, and wherein, as a result of expansion of the annular filter layers (2, 16) on the molding element (12), the amplitude of the undulation decreases to an ever greater extent the further the filter layer (2, 16) is pulled over the molding element (12).

36. The method as claimed in claim 35, further comprising inserting the conically tapering filter layers (2, 16) one inside the other such that those filter layers (2, 16) directly adjacent to one another in a radial direction are arranged alternately with the relatively small cross-sectional area toward the inflow side and toward the outflow side, to achieve an accordion-like construction of the filter body (1), wherein the average cross-section of the filter layers (2, 16) decreases in a radial direction from the outside inward.
